(19) United States
(12) Patent Application Publication
(10) Pub. No.: US 2015/0334703 A1
(43) Pub. Date: Nov. 19, 2015

(54) DETERMINING MODEM INFORMATION AND OVERHEAD INFORMATION

(71) Applicant: QUALCOMM Incorporated, San Diego, CA (US)

(72) Inventors: Changlong XU, Beijing (CN); Liang Zhang, Beijing (CN); Venkata Ramanan Venkatachalam Jayaraman, San Diego, CA (US); Ruowei Wang, Beijing (CN); Rohit Kapoor, San Diego, CA (US); Jilei Hou, Beijing (CN)

(21) Appl. No.: 14/582,767

(22) Filed: Dec. 24, 2014

Related U.S. Application Data
(60) Provisional application No. 61/993,545, filed on May 15, 2014.
(60) Provisional application No. 61/993,551, filed on May 15, 2014.

(51) Int. Cl. H04W 72/04; H04W 28/02; H04L 12/825; H04W 24/10

(52) U.S. Cl. CPC H04W 72/0446; H04W 24/10; H04W 28/0252; H04L 47/25

(57) ABSTRACT

Methods, computer-readable medium, and apparatus are described for adjusting uplink communication at a user equipment (UE) during wireless communication. The described aspects include determining uplink communication characteristic information corresponding to an uplink data rate based on one or more measurement values associated with transmissions by a modem on an uplink communication channel. Further, the described aspects include determining an adjusted uplink data rate based at least in part on the uplink communication characteristic information. Additionally, the described aspects include adjusting data transmission rate of an application layer entity based at least in part on the adjusted uplink data rate.

### CLAIM OF PRIORITY UNDER 35 U.S.C §119

The present Application for Patent claims priority to Provisional Application No. 61/993,545 entitled “METHODS AND APPARATUS FOR DETERMINING MODEM INFORMATION” filed May 15, 2014, and Provisional Application No. 61/993,551 entitled “METHOD AND APPARATUS FOR OVERHEAD DETERMINATION” filed May 15, 2014, both assigned to the assignee hereof and both hereby expressly incorporated herein by reference.

### BACKGROUND

Aspects of the present disclosure relate generally to wireless communication systems, and more particularly, to determining modem information and overhead information.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, inefficient and/or ineffective utilization of available communication resources, particularly data transmission on the uplink, may lead to degradations in wireless communication. Even more, the foregoing inefficient resource utilization inhibits user equipments and/or wireless devices from achieving higher wireless communication quality. Thus, improvements in uplink data transmissions are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, the present methods relate to adjusting uplink communication at a user equipment (UE) during wireless communication. The described aspects include determining uplink communication characteristic information corresponding to an uplink data rate based on one or more measurement values associated with transmissions by a modem on an uplink communication channel. Further, the described aspects include determining an adjusted uplink data rate based at least in part on the uplink communication characteristic information. Additionally, the described aspects include adjusting data transmission rate of an application layer entity based at least in part on the adjusted uplink data rate.

In another aspect, a computer-readable medium storing computer executable code relates to code for adjusting uplink communication at a user equipment (UE) during wireless communication. The described aspects include code for determining uplink communication characteristic information corresponding to an uplink data rate based on one or more measurement values associated with transmissions by a modem on an uplink communication channel. Further, the described aspects include code for determining an adjusted uplink data rate based at least in part on the uplink communication characteristic information. Additionally, the described aspects include code for adjusting data transmission rate of an application layer entity based at least in part on the adjusted uplink data rate.

In a further aspect, an apparatus relates to adjusting uplink communication at a user equipment (UE) during wireless communication. The described aspects include means for determining uplink communication characteristic information corresponding to an uplink data rate based on one or more measurement values associated with transmissions by a modem on an uplink communication channel. Further, the described aspects include means for determining an adjusted uplink data rate based at least in part on the uplink communication characteristic information. Additionally, the described aspects include means for adjusting data transmission rate of an application layer entity based at least in part on the adjusted uplink data rate.

In another aspect, an apparatus relates to adjusting uplink communication at a user equipment (UE) during wireless communication. The described aspects include a determining component configured to determine uplink communication characteristic information corresponding to an uplink data rate based on one or more measurement values associated with transmissions by a modem on an uplink communication channel. Further, the described aspects include an adjusting component configured to determine an adjusted uplink data rate based at least in part on the uplink communication characteristic information. Additionally, the described aspects include an application layer entity configured to adjust a data transmission rate based at least in part on the adjusted uplink data rate.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram of a communication network including an aspect of a user equipment that may transmit data on the uplink according to an adjusted uplink data rate computed based on, at least in part, uplink communication characteristic information derived from measurement values obtained from a modem component and associated with an uplink data channel;

FIG. 2 is a flowchart of an aspect of a method of adjusting a data transmission rate of an application layer entity based at least in part on an adjusted uplink data rate computed based on, at least in part, uplink communication characteristic information derived from measurement values associated with an uplink data channel, in accordance with an aspect of the present disclosure;

FIG. 3A is a flowchart of an aspect of a method of determining uplink communication characteristic information, in particular, modem information, in accordance with an aspect of the method of FIG. 2;

FIG. 3B is a flowchart of an aspect of a method of determining uplink communication characteristic information, in particular, overhead information for a first group of protocol layers, in accordance with an aspect of the method of FIG. 2;

FIG. 3C is a flowchart of an aspect of a method of determining uplink communication characteristic information, in particular, overhead information for a second group of protocol layers, in accordance with an aspect of the method of FIG. 2;

FIG. 4 is a conceptual diagram of an aspect of determining a modem state based on modem information, in accordance with an aspect of the methods of FIG. 2 and FIG. 3A;

FIG. 5 is a block diagram illustrating an example of a hardware implementation for an apparatus employing a processing system configured to adjust a data transmission rate of an application layer entity based at least in part on an adjusted uplink data rate computed based on, at least in part, uplink communication characteristic information derived from measurement values associated with an uplink data channel, in accordance with an aspect of the present disclosure;

FIG. 6 is a block diagram conceptually illustrating an example of a telecommunications system in accordance with an aspect of the present disclosure;

FIG. 7 is a conceptual diagram illustrating an example of an access network in accordance with an aspect of the present disclosure;

FIG. 8 is a conceptual diagram illustrating an example of a radio protocol architecture for the user and control plane in accordance with an aspect of the present disclosure; and

FIG. 9 is a block diagram conceptually illustrating an example of a Node B in communication with a user equipment in a telecommunications system in accordance with an aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

With developments in wireless communication technologies, a greater number of users require high data rate services for applications running on their mobile devices (also referred to herein as user equipment). In order to provide an adequate user experience, it is beneficial for certain applications, such as a video telephony application, to know the uplink data rate of the mobile device. The uplink data rate is an amount of data over a certain time period that can be transmitted over the uplink channel, where the uplink data rate is based on a data capacity of the uplink channel. Moreover, the data capacity of the uplink channel typically fluctuates over time due to factors such as channel fading and varying system load. The impact of such fluctuations on time-sensitive traffic, such as data from a video telephony application, can be severe. For instance if a data generator, such as a video telephony application, is unaware of a sudden drop in channel capacity, it will continue generating data at a rate higher than that supported by the uplink channel. This causes a transmit buffer to grow, leading to a large queuing delay, which translates to a poor user experience. In another example, if the data generator is unaware of the data capacity of the uplink channel improving significantly, then the data generator will likely be very slow in capitalizing on the opportunity. Although in this second case the user experience does not degrade, the user experience is still not as good as the uplink channel allows. Traditionally, the mobile device may rely on end-to-end measurements of the uplink channel to determine an uplink channel capacity and/or uplink data rate, however, such solutions are slow as they often rely on the receiving end device to provide the transmitting device with the relevant metrics. Thus, more quickly understanding and improving the uplink communication allows for improvements in communication quality, and in turn, user experience with the applications operating on the mobile device.

The present aspects generally relate to determining uplink communication characteristic information related to an uplink data rate of an uplink channel based on information available at a modem of a UE (independent of and/or without relying on obtaining metrics from a receiving device and/or other end-to-end communication methods), and then determining an adjusted uplink data rate that can be used by an application layer entity to modify a data transmission rate to control an amount of data generated for transmission by the modem. Moreover, rather than directly using measurement values provided by the modem, the present aspects instead compute uplink communication characteristic information, such as modem information and overhead information, to take into account factors relevant to performance of the application layer entity, thereby allowing for improved uplink communication. For example, the modem information may include a modem communication rate and a modem state, and the overhead information may include one or more overhead values (e.g., related to protocol layer headers and/or padding) each associated with a respective protocol layer entity. As described herein, the modem information and/or overhead information affect how much of the uplink data rate (as measured or experienced by the modem) can be used by the application layer entity, and the present aspects account for this by determining the adjusted uplink data rate, which is a data rate that can be effectively utilized by the application layer entity. As such, the application layer entity, e.g., the video telephony application in this example, may be able to dynamically adjust a data transmission rate based on the adjusted uplink data rate to take advantage of modem-based and/or UE-protocol-layer based adjustments to the physical layer uplink data rate. Accordingly, the application layer entity may be able to more efficiently generate data for uplink transmission by matching the adjusted uplink date rate, thereby avoiding overloading or starving data sent to the modem, which may improve communication quality and/or user experience.

For example, a user equipment executing the present aspects may increase the data transmission rate of the application layer entity when the adjusted uplink data rate reflects modem information received from the modem entity that indicates an upward or increasing rate of change of the uplink data rate, and/or by removing the overhead identified in the overhead information. On the other hand, the UE may decrease the data transmission rate of the application layer entity when the adjusted uplink data rate reflects modem information received from the modem entity that indicates a downward or decreasing rate of change of the uplink data rate and/or when the overhead identified in the overhead information increases. Accordingly, the present methods and apparatus provide enhanced UE communication on the uplink.

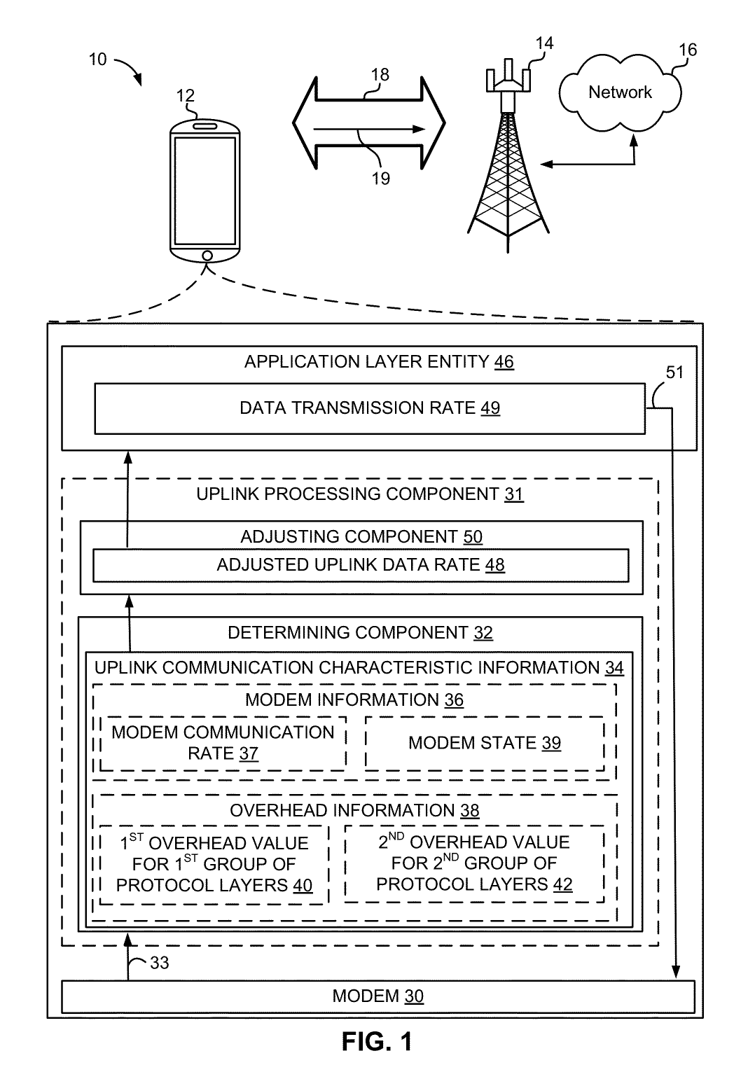

Referring to FIG. 1, in an aspect, a wireless communication system 10 includes at least one UE 12 in communication coverage of at least one network entity 14 (e.g., base station). UE 12 may communicate with network 16 via network entity 14. In some aspects, multiple UEs including UE 12 may be in communication coverage with one or more network entities, including network entity 14. In an example, UE 12 may transmit and/or receive wireless communication to and/or from network entity 14 via one or more communication channels 18, which may include an uplink communication channel 19, such as but not limited to an uplink data channel. Such wireless communications may include, but are not limited to, audio and/or video information.

In such aspects, UE 12 may include an application layer entity 46 that can adjust its data transmission rate 49 based on an adjusted uplink data rate 48 that takes into account uplink communication characteristic information 34 associated with transmissions on the uplink communication channel 19, where the uplink communication characteristic information 34 affects an amount of data 51 that application layer entity 46 may be able to send to modem 30 for transmission over the uplink communication channel 19.

For example, application layer entity 46 may be an application stored on UE 12 and executed by a processor of UE 12, including any application that generates data 51 for transmission by modem 30, such as but not limited to a video telephony application. For example, adjusted uplink data rate 48 may include, but it not limited to, a parameter used by application layer entity 46 to control a data transmission rate 49 of application layer entity 46. Adjusted uplink data rate 48 may be adjusted in the sense that it may be changed in value from another uplink data rate, such as an initially estimated uplink data rate of uplink communication channel 19 as provided by modem 30 or another component of UE 12. Further, for example, uplink communication characteristic information 34 may include modem information 36 and/or overhead information 38, as described below.

In an aspect, for example, UE 12 may include uplink processing component 31 that is configured to calculate adjusted uplink data rate 48 for use by application layer entity 46, where adjusted uplink data rate 48 more specifically takes into account modem information 36 and/or overhead information 38 that may be a part of uplink communication characteristic information 34. In these aspects, the modem information 36 and/or overhead information 38 each may include information that affects how much data 51 can be generated by application layer entity 46 relative to a physical layer uplink data rate determined by modem 30 (where physical layer uplink data rate may be the same as the modem communication rate used by modem 30). In an aspect, uplink processing component 31 may include a determining component 32 configured to calculate the uplink communication characteristic information 34, and an adjusting component 50 configured to calculate adjusted uplink data rate 48 based on the uplink communication characteristic information 34.

For instance, uplink processing component 31 and/or determining component 32 may be configured to communicate with modem 30 to obtain one or more measurement values 33 associated with the uplink communication channel 19, and to determine uplink communication characteristic information 34 that may affect data transmission rate 49 that should be used by application layer entity 46. For example, when uplink communication characteristic information 34 includes modem information, determining component 32 may calculate modem information 36 that includes a modem communication rate 37 calculated to smooth out fluctuations in modem communication rates over a time period, and/or that may be modified (relative to a modem communication rate reported by modem 30) to take into account variations in the reported modem communication rate, and/or that may include information about a modem state 39 that indicates a trend in a value of the modem communication rate.

Also, for example, when uplink communication characteristic information 34 includes overhead information, the overhead information 38 determined by determining component 32 may adjust an amount of overhead associated with the uplink data rate of prior transmissions of data 51, as reported by modem 30, to remove the overheads due to protocol headers in each layer and padding in a transport block. In an aspect, because the amount of overhead may increase when data 51 traverses from the top layer (e.g., the application layer) to the bottom layer (e.g., the physical layer) of the protocol layer stack (based on layer-specific header data and/or padding), the overhead information 38 may include one or more overhead values for each respective layer, or respective values for groups of layers. For instance, in an aspect described in more detail below, the overhead information 38 may include a first overhead value 40 associated with a first group of protocol layers, such as network layers, and a second overhead value 42 associated with a second group of protocol layers, such as air interface layers.

Further, determining component 32 may then send the uplink communication characteristic information 34 to adjusting component 50 for calculation of adjusted uplink data rate 48. For example, adjusting component 50 may be configured to determine adjusted uplink data rate 48, which is different from the physical layer uplink data rate determined by modem 30 (or another physical protocol layer component) based on the influence of the uplink communication characteristic information 34. As noted above, since the modem information 36 and/or overhead information 38 may affect how much of an uplink data rate can be used by application layer entity 46, adjusting component 50 modifies the uplink data rate based at least in part on the uplink communication characteristic information 34. For example, when modem information 36 includes modem communication rate 37 calculated to smooth out fluctuations in modem communication rates over a time period, then adjusted uplink data rate 48 may have less variations over time. Further, for example, when modem information 36 includes modem communication rate 37 calculated to modify a reported modem communication rate to take into account variations in the reported modem communication rate, then adjusted uplink data rate 48 may be dynamically varied to more quickly take advantage of the changes. Also, for example, when modem information 36 includes a value of modem state 39 that indicates a trend in a value of the modem communication rate, then adjusted uplink data rate 48 may be adjusted up or down based on the trend. Moreover, for example, when the overhead information 38 includes first overhead value 40 and/or second overhead value 42, respectively related to different groups of protocol layers, then these overhead values can be used to adjust an amount of overhead associated with the uplink data rate of prior transmissions of data 51. As such, in this case, adjusted uplink data rate 48 may be increased, for example, when removing the overheads due to protocol headers in each layer and padding in a transport block.

Accordingly, adjusting component 50 provides adjusted uplink data rate 48 that can be used by application layer entity 46 to correspondingly adjust data transmission rate 49 to provide a flow of data 51 that may be more efficiently handled by modem 30. For example, application layer entity 46 may change data transmission rate 49 to match adjusted uplink data rate 48, which allows the flow of data 51 generated by application layer entity 46 to better match the amount of data that can be transmitted over uplink communication channel by modem 30. Accordingly, operation of the present aspects may improve uplink communications and/or a user experience.

It should be noted that while uplink processing component 31 (including determining component 32 and adjusting component 50) is described above as being separate from application layer entity 46, in some aspects, uplink processing component 31 (including determining component 32 and adjusting component 50) may be a part of application layer entity 46 or may be another application layer entity in communication with application layer entity 46.

Also, in an aspect, uplink processing component 31 (including determining component 32 and adjusting component 50) and application layer entity 46 may be implemented by computer-executable instructions stored in a computer-readable medium. In some aspect, uplink processing component 31 (including determining component 32 and adjusting component 50) and application layer entity 46 may be implemented in part or as a whole by one or more programmed hardware components, such as by one or more processor modules. Further, in an aspect, modem 30 may be a hardware component that may also include to implement one or more functions in software or firmware, e.g., based on computer-executable instructions stored in a computer-readable medium. In other aspects, modem 30 may be implemented as computer-executable instructions stored in a computer-readable medium and executable by a processor. In additional aspects, modem 30 may be configured to transmit and receive wireless communication on one the one or more communication channels 18 using one or more radio access technologies (RATs) with one or more network entities (e.g., network entity 14). For example, in an aspect, the modem 30 may transmit audio/video information to one or more network entities (e.g., network entity 14) on the uplink communication channel 19. Further, modem 30 may include, but is not limited to, one or more of a transmitter, a receiver or receiver chain, a transceiver, protocol stacks, transmit chain components, and receive chain components.

As used herein, UE 12 may comprise a mobile apparatus and may be referred to as such throughout the present disclosure. Such a mobile apparatus or UE 12 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for Internet-of-Things, or some other suitable terminology.

Additionally, as used herein, the one or more wireless nodes, including, but not limited to, network entity 14 of wireless communication system 10, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 10 may include one or more small cell base stations, such as, but not limited to a femtocell, picocell, microcell, or any other base station having a relatively small transmit power or relatively small coverage area as compared to a macro base station.

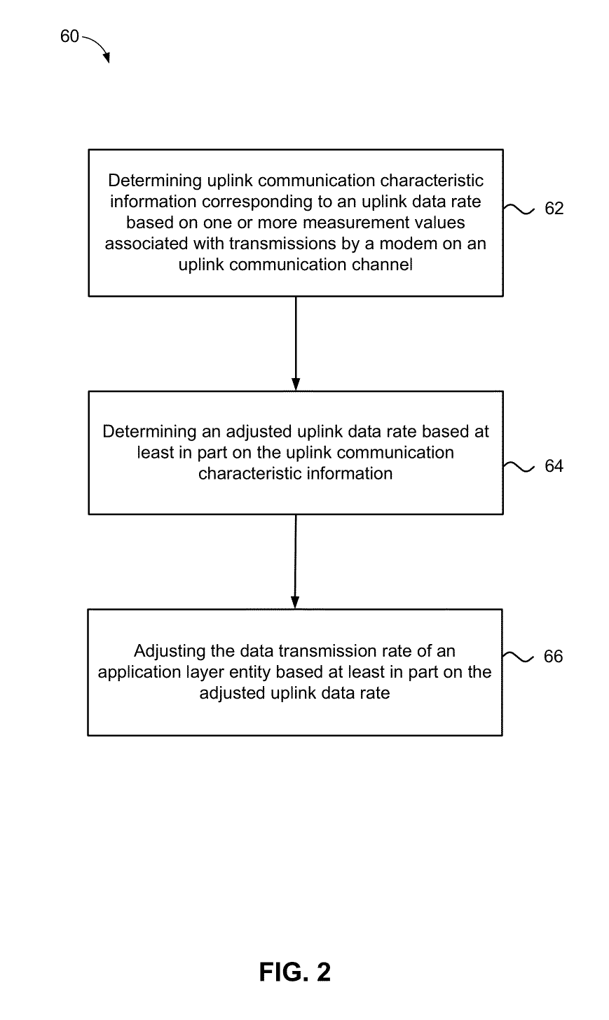

Referring to FIGS. 2, 3A, 3B, 3C and 4, methods related to the operation of the present aspects are shown and described as a series of acts for purposes of simplicity of explanation. However, it is to be understood and appreciated that the method (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein. Additionally, it should be understood that the following actions or functions may be performed by a specially-programmed processor, a processor executing specially-programmed software or computer-executable code stored on a computer-readable medium, or by any other combination of a hardware component and/or a software component capable of performing the described actions.

Referring to FIG. 2, in an aspect of the operation of UE 12 (FIG. 1), UE 12 may perform a method 60 for adjusting an uplink data rate used by an application layer entity for generating data for uplink communication in wireless communication system. For instance, method 60 may be performed by UE 12 via execution of uplink processing component 31 (including determining component 32 and adjusting component 50) operating in cooperation with modem 30 and application layer entity 46, as described herein.

At block 62, method 60 may include determining uplink communication characteristic information corresponding to an uplink data rate based on one or more measurement values associated with transmissions by a modem on an uplink communication channel. For example, as described herein, UE 12 (FIG. 1) may execute uplink processing component 31 and/or determining component 32 to determine uplink communication characteristic information 34 corresponding to an uplink data rate based on one or more measurement values 33 associated with transmissions by a modem 30 on an uplink communication channel 19. For instance, uplink processing component 31 and/or determining component 32 may obtain one or more measurement values 33 from modem 30, where the measurement values 33 may relate to modem characteristics and/or protocol layer overhead characteristics associated with one or more transmission time intervals (TTIs) when modem 30 transmitted data 51 generated by application layer entity 46 over uplink communication channel 19. As such, uplink processing component 31 and/or determining component 32 may compute uplink communication characteristic information 34, which may include modem information 36 relating to characteristics of modem 30 and/or overhead information 38 related to overhead in one or more protocol layers between application layer entity 46 and modem 30. In an aspect, the overhead characterized by overhead information 38 includes protocol layer-specific packet header overhead, e.g., corresponding to several bytes of header added to data 51 at each protocol layer, and/or overhead corresponding to bytes of data added to a packet data unit at a physical layer when a data size of the protocol data unit (PDU) is less than the transport block size.

More specifically, for example, the one or more measurement values 33 that relate to modem information 36 may include, but are not limited to, values obtained over a certain time period for one or more of a modem communication rate or an estimated uplink channel capacity. As such, the one or more measurement values 33 that relate to modem information 36 may be averages or some other mathematical function applied to a series of values. For instance, the modem communication rate may indicate an amount of data that modem 30 may transmit over a time period (e.g., seconds) on an uplink communication channel of modem 30. For example, modem 30 may operate with a modem communication rate indicated in bits per second and/or bytes per second. Further, for instance, the estimated uplink channel capacity may be an estimate of an amount of data transmitted on an uplink communication channel of modem 30 in each of a number of transmission time intervals (TTIs) over a certain time period. For example, the estimated uplink channel capacity may be indicated in bits per second and/or bytes per second. In an aspect, the TTIs considered when computing the estimated uplink channel capacity may include only selected ones of all the TTIs in the time period, e.g., selected TTIs in which data was queued for transmission or retransmission and UE 12 had an uplink grant, and/or where the transmission was successful and the data capacity of the transmission is based on maximum data per grant and maximum data per headroom information.

As such, for example, uplink processing component 31 and/or determining component 32 may be configured to compute the modem information 36 by adjusting a modem communication rate (e.g., which may correspond to the actual uplink data rate) received from modem 30 to smooth out rate fluctuations, which may be due to, for instance, a fading channel. Alternatively, or in addition, uplink processing component 31 and/or determining component 32 may be configured to compute the modem information 36 by adjusting a modem communication rate to take into account changes in the radio conditions of the uplink communication channel. Also, in another alternative or additional aspect, uplink processing component 31 and/or determining component 32 may be configured to compute the modem information 36 to include a modem state that provides an indication of a trend in the rate of change of the modem rate, which may be relevant for adjustments to data transmission rate 49 used by data generator 47 of application layer entity 46.

Further, for example, the one or more measurement values 33 that relate to the overhead information 38 may include, but are not limited to, values obtained over a certain time period for one or more protocol layer packet header size and/or transport block padding size associated with one or more protocol layers (e.g., RLC layer, MAC layer, Physical layer, etc.) through which data 51 is passed before being transmitted by modem 30. As such, the one or more measurement values 33 that relate to overhead information 38 may be averages or some other mathematical function applied to a series of values. The overhead information 38 may be indicated in bits or bytes, or in a percentage or ratio relative to an overall packet size or transport block size associated with a packet data unit for a respective protocol layer. In some instances, the one or more measurement values 33 that relate to the overhead information 38 may be a fixed value or a variable value for each respective protocol layer. In an aspect, for example, when application layer entity 46, such as a video telephony application, is configured to transmit a video stream, the video stream contains overhead information. As the video stream is sent through each protocol layer in a protocol stack of UE 12, additional headers are added, and padding bits may also be added to the transport block, resulting in an extra overhead. As such, the overhead information 38 may include one or both of a first overhead value 40 corresponding to a first group of protocol layers (e.g., a relatively higher set of protocol layers in the protocol stack, such as network-related layers) and a second overhead value 42 corresponding to a second group of protocol layers (e.g., a relatively lower set of protocol layers in the protocol stack, such as air interface-related layers), where the overhead values may vary between each of the different groups of layers.

As such, for example, the overhead information 38 determined by determining component 32 may adjust an amount of overhead associated with the uplink data rate of prior transmissions of data 51, as reported by modem 30, to remove the overheads due to protocol headers in each layer and padding in the transport block.

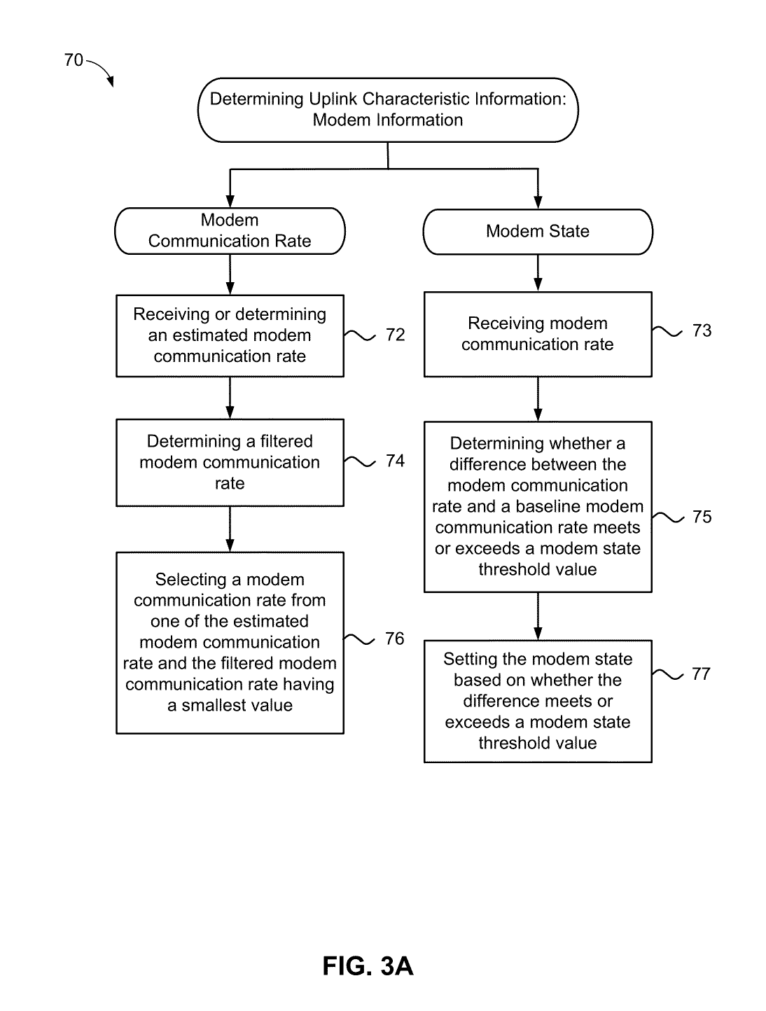

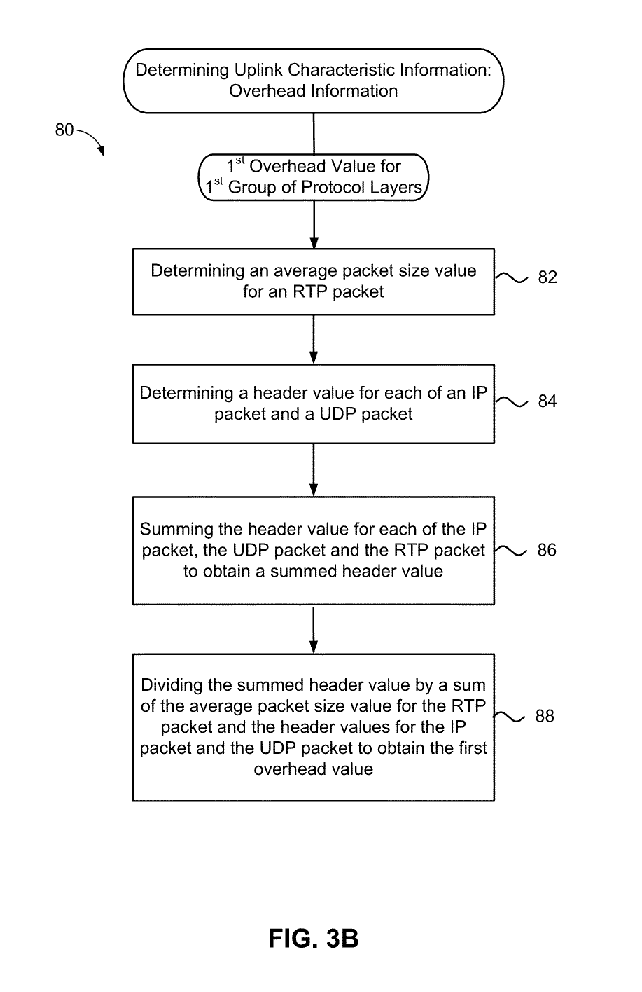

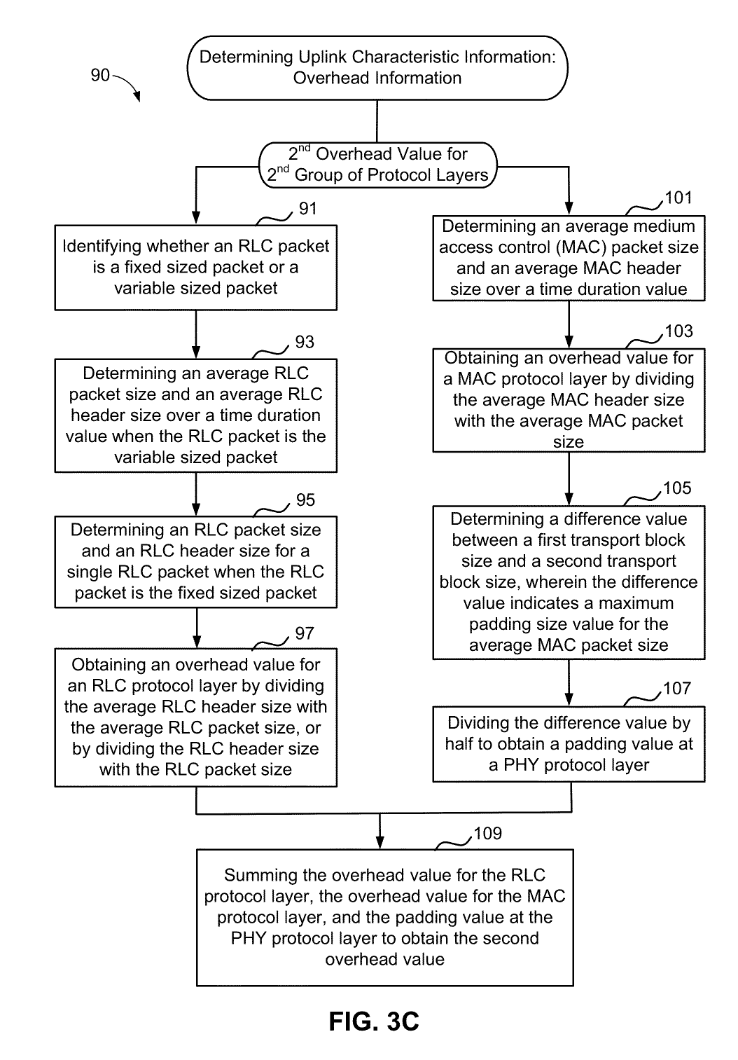

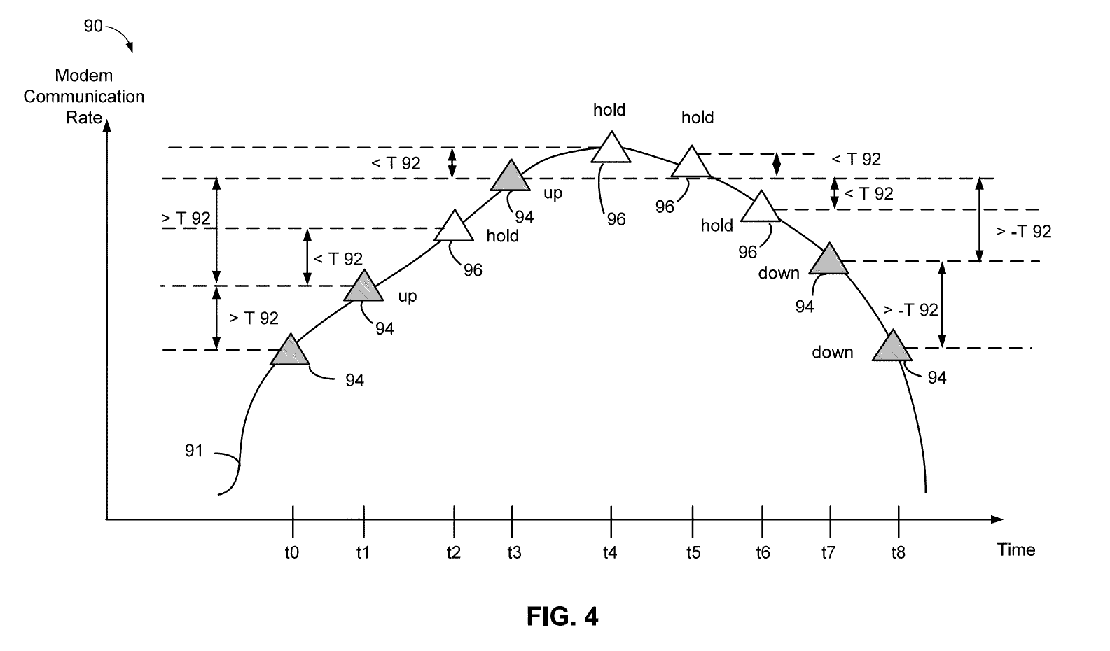

Additional aspects relating to how to determine uplink communication characteristic information 34, and specifically modem information 36, are described below with respect to FIG. 3A and FIG. 4.

Additional aspects relating to how to determine uplink communication characteristic information 34, and specifically overhead information 38, are described below with respect to FIGS. 3B and 3C.

Further, at block 64, method 60 may include determining an adjusted uplink data rate based at least in part on the uplink communication characteristic information. For example, as described herein, UE 12 (FIG. 1) may execute uplink processing component 31 and/or determining component 32 to determine an adjusted uplink data rate 48 based at least in part on the uplink communication characteristic information 34. In an aspect, for example, uplink processing component 31 and/or determining component 32 may receive as an input the respective modem information 36 and/or the respective overhead information 38, and optionally an physical layer uplink data rate of uplink communication channel 19 (e.g., independent of end-to-end metrics from a receiving entity; and, which may be the same as a modem communication rate of modem 30) and may apply a mathematical function or a relative weighting factor to the data to generate a value used to modify physical layer uplink data rate (or modem communication rate of modem 30) to generate adjusted uplink data rate 48. For example, adjusting component 50 may be configured to determine adjusted uplink data rate 48, which is different from the physical layer uplink data rate determined by modem 30 (or another physical protocol layer component) based on the influence of the uplink communication characteristic information 34. As noted above, since the modem information 36 and/or overhead information 38 may affect how much of an uplink data rate can be used by application layer entity 46, adjusting component 50 modifies the uplink data rate based at least in part on the uplink communication characteristic information 34. For example, when modem information 36 smooths out fluctuations in modem communication rates over a time period, then adjusted uplink data rate 48 may have less variations over time. Further, for example, when modem information 36 modifies the modem communication rate to take into account variations in the reported modem communication rate (independent of end-to-end metrics), then adjusted uplink data rate 48 may be dynamically varied to more quickly take advantage of the changes. Also, for example, when modem information 36 includes modem state information that indicates a trend in a value of the modem communication rate, then adjusted uplink data rate 48 may be adjusted up or down based on the trend. Moreover, for example, when the overhead information 38 adjusts an amount of overhead associated with the uplink data rate of prior transmissions of data 51, then the adjusted uplink data rate 48 may be increased, for example, when removing the overheads due to protocol headers in each layer and padding in a transport block.

Moreover, at block 66, method 60 may include adjusting data transmission rate of an application layer entity based at least in part on the adjusted uplink data rate. For example, as described herein, UE 12 (FIG. 1) may execute application layer entity 46 and/or adjusting component 50 to adjust data transmission rate 49 of application layer entity 46 based at least in part on the adjusted uplink data rate 48. In an aspect, for example, application layer entity 46 and/or adjusting component 50 may receive as an input at least the adjusted uplink data rate 48 (and, in some aspects, one or more of uplink communication characteristic information 34) and may apply a mathematical function that relates uplink data rates to data transmission rates, or may refer to a mapping of uplink data rates to data transmission rates, to adjust data transmission rate 49 of application layer entity 46. For example, application layer entity 46 may change data transmission rate 49 to match adjusted uplink data rate 48, which allows the flow of data 51 generated by application layer entity 46 to better match the amount of data that can be transmitted over uplink communication channel by modem 30.

Thus, based on operation of method 60, application layer entity 46 of UE 12 may more efficiently provide data 51 to modem 30 for transmission over uplink communication channel 19.

Referring to FIG. 3A, method 70 represents one example of a more detailed aspect of determining uplink characteristic information (FIG. 2, block 62), in particular with respect to determining modem information 36, which may include one or both of modem communication rate and/or modem state.

In an aspect where modem information 36 includes a modem communication rate, for example, at block 72, method 70 may include receiving or determining an estimated modem communication rate. For example, in an aspect, uplink processing component 31 and/or determining component 32 may be configured to receive or determine an estimated modem communication rate, which may be a part of modem information 36. For example, in an aspect, the estimated modem communication rate may correspond to an uplink channel capacity estimate, which in one aspect may be determined by summing the data capacities of individual transfer time intervals (TTI) over a period of time that corresponds to a transmit window length.

At block 74, method 70 may include determining a filtered modem communication rate. For example, in an aspect, uplink processing component 31 and/or determining component 32 may be configured to determine a filtered modem communication rate, which may be a part of modem information 36. For example, the filtered modem communication rate may be determined based at least in part on a smoothing filter applied to the estimated modem communication rate. Further, the filtered modem communication rate may be determined based at least in part on a channel specific coefficient value and the estimated modem communication rate. For instance, uplink processing component 31 and/or determining component 32 may be configured to filter the estimated modem communication rate using a smoothing filter to produce the filtered modem communication rate. In such aspects, the smoothing filter is configured to flatten a variation in the estimated modem communication rate that exceeds a threshold. In such aspects, the channel specific coefficient value may be a channel specific value indicative of a level of variation. As such, the filtered modem communication rate may flatten or smooth out fluctuations that exceed a threshold in the estimated modem communication rates detected per TTI.

At block 76, method 70 may include selecting a modem communication rate from one of the estimated modem communication rate and the filtered modem communication rate having a smallest value. For example, in an aspect, uplink processing component 31 and/or determining component 32 may be configured to select a modem communication rate from one of the estimated modem communication rate and the filtered modem communication rate having a smallest value, which may be a part of modem information 36. Specifically, in an aspect, to determine the modem information 36 including the modem communication rate, uplink processing component 31 and/or determining component 32 may be configured to select a minimum of, or a smallest rate from, the estimated modem communication rate and the filtered modem communication rate. That is, the uplink processing component 31 and/or determining component 32 may select the smaller of the current values for the two rates. For example, the resulting modem communication rate may indicate a rate of data transmission over a time period (e.g., seconds or ms) on an uplink communication channel, as determined, for instance, based on the minimum of the estimated modem communication rate and the filtered modem communication rate. In other words, the modem communication rate may indicate an estimated data rate on the uplink communication channel.

In an example use case of blocks 72, 74, and 76, which should not be construed as limiting, the modem communication rate may be determined or otherwise calculated based on a formulaic aspect by the determining component 32. In some aspects, the determining component 32 may periodically request one or more measurement values 33 related to modem information 36 from the modem 30. For instance, the determining component 32 may receive one or more measurement values 33, such as data transmitted per TTI, for each TTI over a time period, and may calculate an initial estimated uplink data rate, which may be the same as an estimated modem communication rate, R_est, for each TTI. Then, according to the present aspects, the initially calculated R_est may be further filtered to account for channel fading. For example, in a fading channel, the fluctuation of the values of R_est may be relatively large as compared to a channel that is not experiencing fading. Accordingly, in an attempt to smoothen or otherwise attenuate the estimate, the filter may be applied to the sequence of R_est (e.g., for each TTI). The output of the filter, which may be denoted by R_f, may be expressed as: R_f=(1−γ)R_f+γ*R_est, where the coefficient y may be optimized for different channels. Subsequently, the modem communication rate may be determined or otherwise calculated by the determining component 32. In particular, with the filter, the value of R_f may not respond quickly to the variations of an uplink channel bandwidth and/or data rate capability. In applications such as video telephony, the modem communication rate should respond as fast as possible when the channel data rate drops. Since R_est responds to the variation of the channel quickly, the minimum between R_est and R_f may be selected as the modem communication rate, R_m, to be used by adjusting component 50 in computing adjusted uplink data rate 48. The selection may be expressed as R_m=min(R_f, R_est). In such aspects, the adjusted uplink data rate 48 may be aggressive (e.g., a relatively large change relative to the prior uplink data rate) and/or fast when the rate is going down (e.g., decreasing) and conservative (e.g., a relatively small change relative to the prior uplink data rate) and/or slow when the rate is going up (e.g., increasing).

In an alternative or additional aspect where modem information 36 includes a modem state, for example, at block 73, method 70 may include identifying a modem communication rate. For example, in an aspect, uplink processing component 31 and/or determining component 32 may be configured to identify a modem communication rate, which may be a part of modem information 36, and which may be the modem communication rate selected at block 76. For instance, the identified modem communication rate at block 73 may be the modem communication rate selected by uplink processing component 31 and/or determining component 32 at block 76. In an aspect, the modem communication rate may be a floating point value.

At block 75, method 70 may include determining whether a difference between the modem communication rate and a baseline modem communication rate meets or exceeds a modem state threshold value. For example, in an aspect, uplink processing component 31 and/or determining component 32 may be configured to determine whether a difference between the modem communication rate (from block 73) and a baseline modem communication rate meets or exceeds a modem state threshold value, where the modem state threshold may have a value such that exceeding the modem state threshold indicates a change in the trend of the modem communication rate. Further, for example, the baseline modem communication rate may be a prior modem communication rate corresponding to a last time the difference exceeded a threshold. In other words, the baseline modem communication rate does not include a prior modem communication rate where the trend of the rate was not identified as increasing or decreasing. In an aspect, the modem threshold value may be configured differently for each distinct channel type.

At block 77, method 70 may include setting the modem state based on whether the difference meets or exceeds a modem state threshold value. For example, in an aspect, uplink processing component 31 and/or determining component 32 may be configured to set the modem state based on whether the difference meets or exceeds a modem state threshold value, e.g., to a “hold” state if the threshold is not exceeded, to an “up” state if there is a positive difference greater than the threshold, and to a “down” state if there is a relative decrease in the rate greater than the threshold. Moreover, the modem state may include or be identified by one or more bits, such as at least two bits, indicating an increasing or decreasing direction in a rate of change of the modem communication rate, or no change in the rate of change of the modem communication rate. As such, the modem state represents the trend and/or expected trajectory of the rate change for the modem communication rate. Such information may be used by the application layer entity 46, which may include an application such as, but not limited to, video telephony. Further, if the modem state is “up” or “down”, then uplink processing component 31 and/or determining component 32 update the baseline modem communication rate to the current modem communication rate and store the updated value. If the modem state is “hold”, then uplink processing component 31 and/or determining component 32 do not need to change the existing, stored value of the baseline modem communication rate.

Additionally, in one example, uplink processing component 31 and/or determining component 32 may be configured to send or provide the modem state to the adjusting component 50 to indicate the “up” state representing an increase in a rate of change in the modem communication rate when, for example, the difference value meets or exceeds the modem state threshold value. Further, in another example, uplink processing component 31 and/or determining component 32 may be configured to send or provide the modem state to the adjusting component 50 to indicate the “down” state representing a decrease in a rate of change in the modem communication rate when, for instance, the difference value does not meet or exceed the modem threshold value. In yet another example, uplink processing component 31 and/or determining component 32 may be configured to send or provide the modem state to the adjusting component 50 to indicate the “hold” state when the difference value falls below the modem threshold value. In other words, when an absolute value of the difference value between the current modem communication rate and the modem baseline rate does not meet or exceed the modem state threshold value (e.g., in a positive or negative direction), the “hold” state indicates no substantial change in the rate of change in the modem communication rate.

Additional aspects of how the modem state is determined are described below and illustrated in FIG. 4.

For example, referring to FIG. 4, a conceptual diagram 99 illustrates one non-limiting example of how to determine the modem state based on modem communication rates reported over time. In this example, the conceptual diagram 99 illustrates a series of modem states for a modem, such as modem 30 of FIG. 1, based on comparing the difference between a currently reported modem communication rate and a baseline modem communication rate to a modem state threshold. In particular, conceptual diagram 99 illustrates the algorithm for determining whether to change or hold the modem state, where the modem state may take one of the following values: hold, up, and down. These values may describe the trend of the modem communication rate (which may be the same as or may correlate to an uplink data rate on uplink communication channel 19 of FIG. 1) over time, which is represented by line 98. As such, the modem state may be used by adjusting component 50 to determine adjusted uplink data rate 48 for use by application layer entity 46 in order to correspondingly control data transmission rate 49.

According to the present aspects, uplink processing component 31 and/or determining component 32 may be programmed with a modem state threshold (T) 92 having a value that indicates an increasing or decreasing change in the modem communication rate. The value of T 92 may depend on the implementation, such as based on what size change in modem rate should be considered a substantial enough increase or decrease so as to be taken into account when computing adjusted uplink data rate 48. The triangles in FIG. 4 represent the instant modem communication rates, which may be reported to uplink processing component 31 and/or determining component 32 as part of the one or more measurement values 33. The triangles that are shaded represent baseline modem communication rates 94, which may be defined as a modem communication rate in which the corresponding modem state is determined to be up or down. The triangles that are not shaded represent modem communication rates associated with a modem state of hold 96. The baseline modem communication rate 94 at time t0 may be initialized as the first modem communication rate. When the modem communication rate is received, then uplink processing component 31 and/or determining component 32 calculates the difference D between the currently reported modem communication rate and latest baseline rate 94, and the difference D is compared to the threshold T 92. Accordingly, uplink processing component 31 and/or determining component 32 determine the modem state as follows:

$$state = \{ \begin{matrix}Up & if D >= threshold \\ Down & if D < - threshold \\ Hold & the others\end{matrix}$$

In such aspects, the threshold (e.g., T 92) may be configurable for different channel types. For example, the channel types may include standard ITU types Pedestrian A (PA3) and Pedestrian B (PB3) multipath types, and Vehicular A (VA30 and/or VA120) multipath type. In one instance, the threshold (e.g., T 92) may be set to 50 kbps for PA3 channel.

If the modem state is up or down, the baseline modem communication rate 94 may be updated to the current modem communication rate. For example, at time t1, the value of the difference D between the currently reported modem communication rate and the last baseline modem communication rate (at t0) is greater than the value of threshold T 92. As such, the baseline modem communication rate 94 may be updated to the currently reported modem communication rate at t1. In other words, at t1, the currently reported modem communication rate has increased in value significantly enough to be considered a new baseline. Similarly, for example, at time t7, the value of the difference D between the currently reported modem communication rate and the last baseline modem communication rate, which is at t3 since the rates at t4, t5, and t6 were associated with a modem state of hold, is greater than the value of threshold T 92. As such, the baseline modem communication rate 94 may be updated to the currently reported modem communication rate at t7. In other words, at t7, the currently reported modem communication rate has decreased in value significantly enough to be considered a new baseline. As such, the value of difference D may be an absolute value.

If the modem state is hold, then the baseline modem communication rate 94 may not be updated to the current modem communication rate. For example, at time t5, the value of the difference D between the currently reported modem communication rate and the last baseline modem communication rate (at t3 since t4 is associated with a modem state of hold) is less than the value of threshold T 92. As such, the baseline modem communication rate 94 remains the baseline modem communication rate 94 at t3.

Accordingly, adjusting component 50 may be configured to determine an adjustment level to an uplink data rate based on the modem information 36, such as the modem communication rate and/or the modem state, received from the determining component 32. For example, the modem communication rate may provide an indication to the adjusting component 50 of the rate of data transmission over or per a period of time (e.g., seconds) on an uplink communication channel 19, and the modem state may provide an indication as a trend in the rate of change of the modem communication rate.

For example, adjusting component 50 may determine that the modem communication rate may be associated with an increasing rate trend or direction based on the modem state indicating an up state. As such, adjusting component 50 may provide an increased factor or weighting associated with modem information 36 that may bias an increase the level of adjusted uplink data rate 48 to account for the modem communication rate trending upward. On the other hand, adjusting component 50 may determine that the modem communication rate may be associated with a decreasing rate trend or direction based on the modem state indicating a down state. As such, adjusting component 50 may provide a decreased factor or weighting associated with modem information 36 that may bias a decrease in the level of adjusted uplink data rate 48 to account for the modem communication rate trending downward. In other aspects, adjusting component 50 may determine that the modem communication rate may be substantially steady state based on the modem state indicating a hold state. As such, adjusting component 50 may provide an unchanged factor or weighting associated with modem information 36 that may bias maintaining a level of adjusted uplink data rate 48 to account for the modem communication rate being steady state.

Referring to FIG. 3B and FIG. 3C, method 80 and method 90, respectively, relate to examples of a specific aspect of determining uplink communication characteristic information, which is more generally discussed above with respect to FIG. 2, block 62 of method 60. In particular, method 80 relates to an aspect of determining a first overhead value 40 associated with a first group of protocol layers of the protocol stack on UE 12 through which data 51 (FIG. 1) is sent before arriving at modem 30. Similarly, method 90 relates to an aspect of determining a second overhead value 42 associated with a second group of protocol layers of the protocol stack on UE 12 through which data 51 (FIG. 1) is sent before arriving at modem 30.

In other words, after being generated by application layer entity 46, such as a video telephony application, the data 51, which in one example may be source encoded video data, is packed at each layer of the protocol stack, where a protocol layer-specific header (ranging in size, for example, from 2 bytes to 20 bytes) is added at each protocol layer. For instance, data 51 is packed as real-time protocol (RTP) packets, then as user datagram protocol (UDP) packets, then as internet protocol (IP) packets, then as packet data convergence protocol (PDCP) packets, then as radio link control (RLC) packets, then as multi-media access control (MAC) packets, then as physical (PHY) packets. Additionally, in the PHY layer, overhead in the form of padding bits may be added when the data size of the MAC packet data unit (PDU), e.g., the packet the PHY receives from the MAC, is less than a transport block size used by the PHY layer. In an aspect, the protocol layers may be grouped, such as into a first group of protocol layers, such as network-related layers (e.g., RTP, UDP, and IP), and a second group of layers, such as air interface layers (RLC, MAC, and PHY; PDCP may not be included as PDCP is not used in most commercial networks).

Thus, method 80 provides one example of determining first overhead value 40 associated with network-related protocol layers, while method 90 provides one example of determining second overhead value 42 associated with air interface-related protocol layers. One or both of method 80 and/or method 90 may be implemented at block 62 of method 60 (FIG. 2).

Referring specifically to FIG. 3B, method 80 is one non-limiting example of determining first overhead value 40 associated with a first group of protocol layers of the protocol stack on UE 12 through which data 51 (FIG. 1) is sent before arriving at modem 30. In one non-limiting example, the first group of protocol layers may be network-related layers, including one or more of an Internet Protocol (IP) layer, a User Datagram Protocol (UDP) layer, and a Real-Time Protocol (RTP) layer. For example, the IP protocol layer may correspond to an Internet Layer used to transport datagrams (packets) from the originating host across network boundaries, if necessary, to the destination host specified by a network address (IP address) which is defined for this purpose by the IP. Further, for example, the UDP protocol layer may correspond to a Transport Layer that provides end-to-end or host-to-host communication services for applications within a layered architecture of network components and protocols. Also, for example, the RTP protocol layer may correspond to an Application Layer, which is an abstraction layer that specifies the shared protocols and interface methods used by hosts in a communications network.

First overhead value 40 may be a number, e.g., in bytes, or a percentage or ratio (as detailed in method 80) of a size of overhead data relative to overall packet size. For example, in an aspect where first overhead value 40 is represented as a number of bytes, uplink processing component 31 and/or determining component 32 may be configured to determine a header value for each of the IP packet, the UDP packet, and the RTP packet, and first overhead value 40 may be a sum of these header values. For example, in an aspect where first overhead value 40 is represented as a percentage or ratio (as detailed in method 80), uplink processing component 31 and/or determining component 32 may be configured to take the sum of the header values for each of the IP packet, the UDP packet, and the RTP packet, and divide this summed header value by an average packet size of the IP packets (including the above-noted headers). Also, as indicated in the description of FIG. 1, first overhead value 40 may be a part of overhead information 38 and/or uplink communication characteristic information 34.

In an aspect, at block 82, method 80 may include determining an average packet size value for an RTP packet. For example, in an aspect, uplink processing component 31 and/or determining component 32 may be configured to determine an average packet size value for an RTP packet. For instance, in a UMTS system, as the size of the RTP packet may vary depending on the amount of data payload in the packet, and the RTP header is 12 bytes, so method 80 takes an average of the sizes of the RTP packets (including the size of the RTP header) over a time period.

At block 84, method 80 may include determining a header value for each of an IP packet and a UDP packet. For example, in an aspect, uplink processing component 31 and/or determining component 32 may be configured to determine a header value for each of an IP packet and a UDP packet. For instance, the UDP and IP layers merely add their respective protocol layer-specific headers to the RTP packet. For example, in a UMTS system, the UDP header is 8 bytes and the IP header is 20 bytes.

At block 86, method 80 may include summing the header value for each of the IP packet, the UDP packet and the RTP packet to obtain a summed header value. For example, in an aspect, uplink processing component 31 and/or determining component 32 may be configured to sum the header value for each of the IP packet, the UDP packet and the RTP packet to obtain a summed header value. For example, in a UMTS system, the RTP header is 12 bytes, the UDP header is 8 bytes and the IP header is 20 bytes. As such, the summed header value is 40 bytes.

At block 88, method 80 may include dividing the summed header value by a sum of the average packet size value for the RTP packet and the header values for the IP packet and the UDP packet to obtain the first overhead value. For example, in an aspect, uplink processing component 31 and/or determining component 32 may be configured to divide the summed header value by a sum of the average packet size value for the RTP packet and the header values for the IP packet and the UDP packet to obtain the first overhead value 40. In other words, in this case, the first overhead value 40 may be a ratio or percentage of overhead per average IP packet size. In this case, for a UMTS system, the summed header value is 40 bytes, the average size of the RTP packet may be represented by a variable, N, that includes the RTP header size, and the header values for the IP packet and the UDP packet are 20 bytes and 8 bytes, respectively. Thus, first overhead value 40 in this case is a number that represents a ratio of overhead per IP packet, and first overhead value 40 in this case is equal to 40 bytes divided by (N bytes+20 bytes+8 bytes).

Thus, adjusting component 50 (FIG. 1) may utilize first overhead value 40 to determine adjusted uplink data rate 48. For example, if first overhead value 40 has increased relative to a prior first overhead value used to calculate a prior adjust uplink data rate, then adjusting component 50 may increase a value of adjusted uplink data rate 48 as the extra protocol layer-specific overhead would otherwise limit an amount of data 51 that is ultimately received at modem 30 for transmission over uplink communication channel 19. Alternatively, for example, if first overhead value 40 has decreased relative to a prior first overhead value used to calculate a prior adjust uplink data rate, then adjusting component 50 may decrease a value of adjusted uplink data rate 48 as the reduced protocol layer-specific overhead would otherwise cause queuing of data 51 at modem 30. In other words, adjusting component 50 essentially may remove the protocol layer-specific overhead in order to determine an amount of data 51 that can be received at modem 30 and transmitted over uplink communication channel 19 to achieve a certain uplink data rate.

Referring specifically to FIG. 3C, method 90 is one non-limiting example of determining second overhead value 42 associated with a second group of protocol layers of the protocol stack on UE 12 through which data 51 (FIG. 1) is sent before arriving at modem 30. For example, in an aspect, uplink processing component 31 and/or determining component 32 may be configured to determine the second overhead value 42 for a second group of protocol layers that correspond to air interface protocol layers. In particular, the second group of protocol layers may include one or more of a packet data convergence protocol (PDCP) layer, a radio link control (RLC) protocol layer, a medium access control (MAC) protocol layer, and a physical (PHY) protocol layer. It should be noted that the PDCP layer is not considered in the following example, however, as the PDCP layer is not used in a majority of commercial wireless communication networks.

At block 91, method 90 may include identifying whether an RLC packet is a fixed sized packet or a variable sized packet. For example, in an aspect, uplink processing component 31 and/or determining component 32 may be configured to identify whether an RLC packet is a fixed sized packet or a variable sized packet. In a UMTS system, for example, the structure of an RLC data PDU may be fixed or variable. So, in order to compute second overhead value 42 for a group of protocol layers that includes the RLC layer, uplink processing component 31 and/or determining component 32 may inspect RLC data PDUs over a certain time period or time duration to determine whether they have a fixed or variable size.

At block 93, method 90 may include determining an average RLC packet size and an average RLC header size over a time duration value when the RLC packet is the variable sized packet. For example, in an aspect, uplink processing component 31 and/or determining component 32 may be configured to determine an average RLC packet size and an average RLC header size over a time duration value when the RLC packet is the variable sized packet. For the case of the variable sized RLC packet, the overhead can be calculated by dividing an average header size by an average RLC packet size for the corresponding data 51 received at modem 30 over a time duration.

At block 95, method 90 may include determining an RLC packet size and an RLC header size for a single RLC packet when the RLC packet is the fixed sixed packet. For example, in an aspect, uplink processing component 31 and/or determining component 32 may be configured to determine an RLC packet size and an RLC header size for a single RLC packet when the RLC packet is the fixed sixed packet. In other words, in contrast to block 93, for a fixed RLC packet size, uplink processing component 31 and/or determining component 32 can simplify the overhead calculation as being the fixed RLC header size divided by the fixed RLC packet size. For example, in the case of a fixed RLC data PDU packet size in a UMTS system, the packet size may be fixed at 42 bytes. For simplification, uplink processing component 31 and/or determining component 32 may assume the average size of the corresponding RLC PDU header is 2 bytes. Thus, the overhead for the RLC packet header is calculated as 2 bytes divided by 42 bytes, which equals about a 5% overhead. As such, in this example, 5% may be selected as the overhead associated with the RLC protocol layer (note: this computation may include the consideration that control PDUs do not carry any data from upper layers).

At block 97, method 90 may include obtaining an overhead value for an RLC entity by dividing the average RLC header size with the average RLC packet size, or by dividing the RLC header size with the RLC packet size. For example, in an aspect, uplink processing component 31 and/or determining component 32 may be configured to obtain an overhead value for an RLC entity by dividing the average RLC header size with the average RLC packet size or the RLC header size with the RLC packet size.

At block 101, method 90 may include determining an average medium access control (MAC) packet size and an average MAC header size over a time duration value. For example, in an aspect, uplink processing component 31 and/or determining component 32 may be configured to determine an average medium access control (MAC) packet size and an average MAC header size over a time duration value. Since the header size and packet size of a MAC PDU are both variable, uplink processing component 31 and/or determining component 32 may be configured to determine an average MAC packet size and an average MAC header size over a time duration value when, for example, a MAC packet is a variable sized packet.

At block 103, method 90 may include obtaining an overhead value for a MAC protocol layer by dividing the average MAC header size with the average MAC packet size. For example, in an aspect, uplink processing component 31 and/or determining component 32 may be configured to obtain an overhead value for a MAC protocol layer by dividing the average MAC header size with the average MAC packet size for TTIs over a certain time duration. Since the header size and packet size of a MAC PDU are both variable, uplink processing component 31 and/or determining component 32 may simply divide the above-determined average header size by the above-determined average packet size in a certain time duration in order to obtain the overhead value for the MAC protocol layer. It should be noted that in some aspects, to reduce the computing complexity, some simplifications may be applied. For example, the structure of MAC-d PDU in UMTS includes a 6-bit transmission sequence number (TSN), a 6-bit indicator of the number of MAC-d PDUs, and a 6-bit Data Description Indicator (DDI), which may be used to determine the logical channel, MAC-d flow and size of the MAC-d PDUs. Further, for simplification, 3 bytes may be chosen for the average header per transport block size. Then, for example, if considering a moderate transport block size of 10,000 bits (the maximum transport block size may be 20,000 bits), then the overhead for the header in MAC layer may be 24/10,000=0.24%.

At block 105, method 90 may include determining a difference value between a first transport block size and a second transport block size, wherein the difference value indicates a maximum padding size value for the average MAC packet size. For example, in an aspect, uplink processing component 31 and/or determining component 32 may be configured to determine a difference value between a first transport block size and a second transport block size, wherein the difference value indicates a maximum padding size value for the average MAC packet size. For instance, the padding applied to a MAC PDU by the physical (PHY) protocol layer may be another kind of overhead. There are approximately 128 candidates for the transport block size. The transport block with size equal to MAC PDU may be used if available. If an exact match is not possible, the next larger transport block may be used and padding fills in the gap. As such, the difference between two continuous candidates may be the maximum possible padding size.

At block 107, method 90 may include dividing the difference value by half to obtain a padding value at a physical (PHY) protocol layer. For example, in an aspect, uplink processing component 31 and/or determining component 32 may be configured to divide the difference value by half to obtain a padding value at the PHY protocol layer. For instance, if the RLC buffer is continuous, then the average padding may be half of the maximum possible padding size.

At block 109, method 90 may include summing the overhead value for the RLC protocol layer, the overhead value for the MAC protocol layer, and the padding value at the PHY protocol layer to obtain the second overhead value. For example, in an aspect, uplink processing component 31 and/or determining component 32 may be configured to sum the overhead value for the RLC protocol layer, the overhead value for the MAC protocol layer, and the padding value at the PHY protocol layer to obtain the second overhead value 42.

Second overhead value 42 may be a number, e.g., in bytes, or a percentage or a ratio of a size of overhead data relative to overall packet size for air interface layer packets over a certain time duration. For example, in an aspect, second overhead value 42 may be a ratio that is a sum of the ratio of a header overhead ratio in the RLC protocol layer, a header overhead ratio in the MAC protocol layer, and a padding ratio in the MAC protocol layer. Also, as indicated in the description of FIG. 1, second overhead value 42 may be a part of overhead information 38 and/or uplink communication characteristic information 34.

Moreover, in an aspect, the first overhead value 40 from method 80 and the second overhead value 42 from method 90 may be calculated over a same time duration and summed to obtain the overhead information 38. Adjusting component 50 may then remove the overhead information 38 from consideration when determining adjusted uplink data rate 48. In other words, by removing the effect of protocol layer-specific overheads as represented by overhead information 38, the adjusted uplink data rate 48 is a more realistic rate to be matched by application layer entity 46 in order to control data transmission rate 49 to efficiently supply data 51 to modem 30. As such, application layer entity 46 may be configured to take into account the removal of the overhead information 38 from the data transmission on the uplink when determining data transmission rate 49.

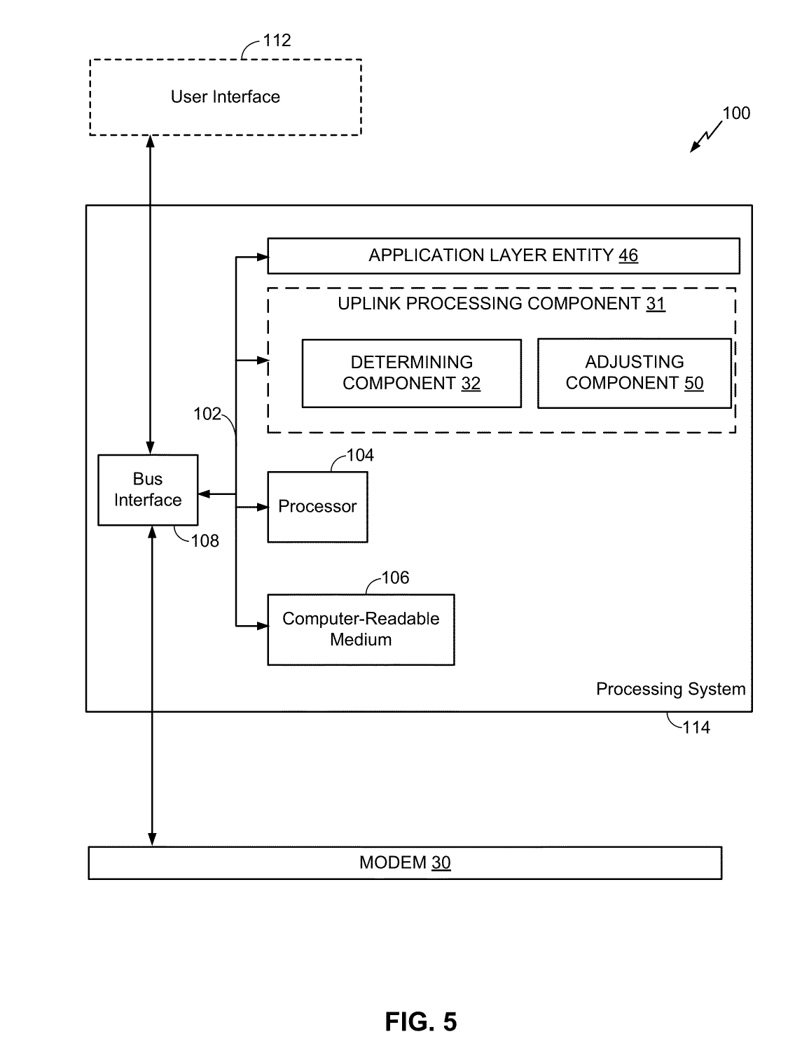

FIG. 5 is a block diagram illustrating an example of a hardware implementation for an apparatus 100 employing a processing system 114, wherein the apparatus may be the same as or similar to UE 12 executing at least uplink processing component 31 (FIG. 1). In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106, and UE components (e.g., UE 12), such as uplink processing component 31 (FIG. 1) and its subcomponents, such as determining component 32 and adjusting component 50.

The bus 102 may also link various other circuits such as timing sources, peripherals, voltage regulators, and power management circuits, which are well known in the art, and therefore, will not be described any further. A bus interface 108 provides an interface between the bus 102 and a modem 30. The modem 30 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

Further, uplink processing component 31 (FIG. 1), or at least some of its functions, may be implemented by any one or more of processor 104 and computer-readable medium 106 (e.g., data and/or instructions stored in computer-readable medium 106). For example, the processor and/or computer-readable medium 106 may be configured to, via uplink processing component 31 and/or determining component 32, to determine uplink communication characteristic information at modem 30 and send the uplink communication characteristic information to application layer entity 46. Furthermore, the processor and/or computer-readable medium 106 may be configured to, via uplink processing component 31 and/or adjusting component 50 to adjust the uplink data rate of modem 30 based on the uplink communication characteristic information.

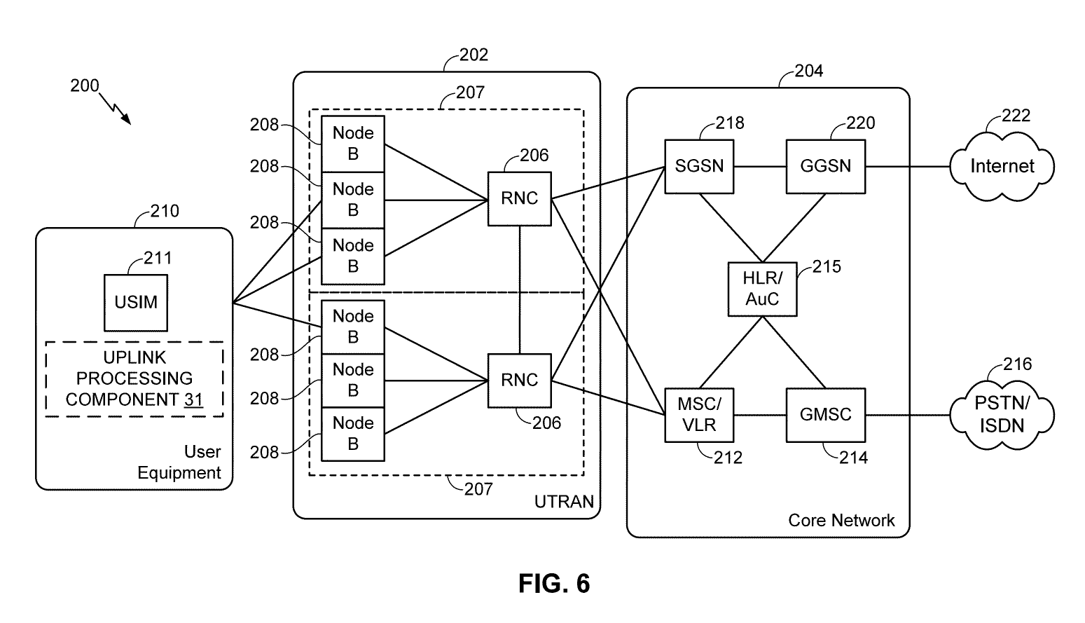

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210 that may be the same as or similar to UE 12 including uplink processing component 31 (FIG. 1). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses.

Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

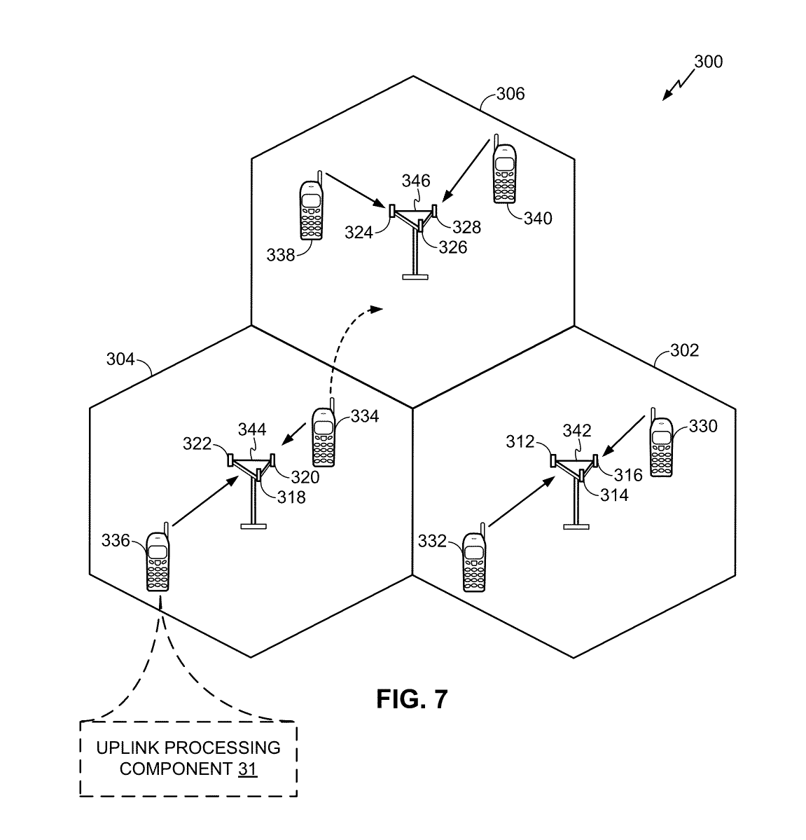

Referring to FIG. 7, an access network 300 in a UTRAN architecture is illustrated in which a UE, such as a UE the same as or similar to UE 12 (FIG. 1) may operate. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 4) for all the UEs 330, 332, 334, 336, 338, 340 in the respective cells 302, 304, and 306. In an aspect, the UEs 330, 332, 334, 336, 338 and/or 340 may include uplink processing component 31 (FIG. 1).

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 5), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

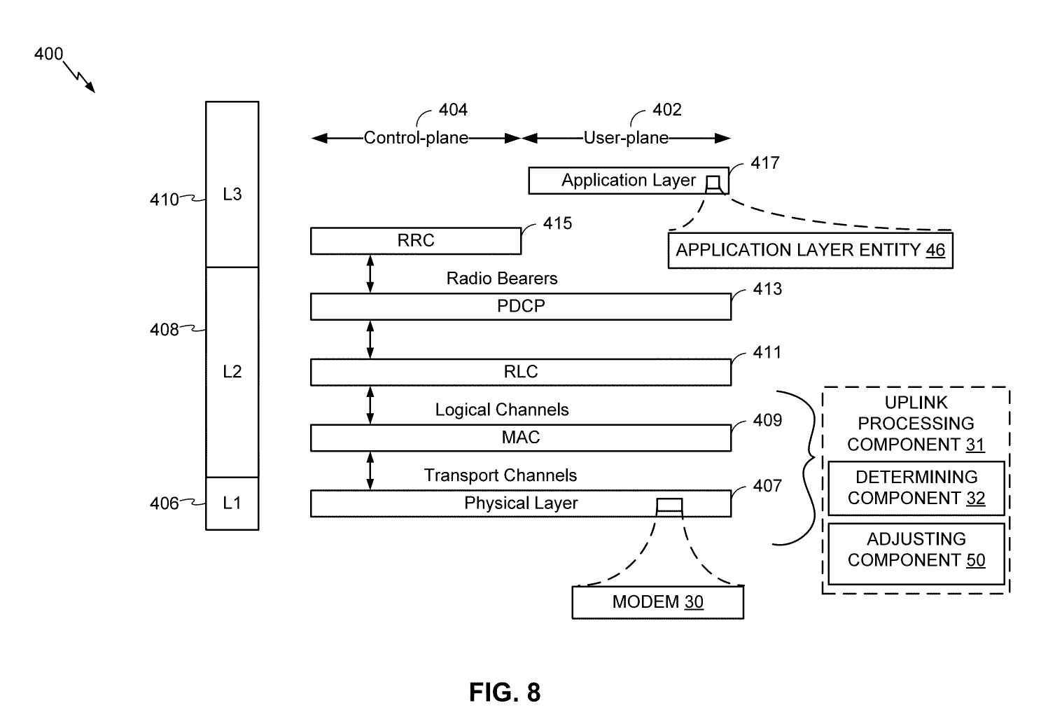

The radio protocol architecture may take on various forms depending on the particular application. An example for an HSPA system will now be presented with reference to FIG. 8.

Referring to FIG. 8, an example radio protocol architecture 400 relates to the user plane 402 and the control plane 404 of a user equipment (UE) 12 or network entity 12, such as a node B/base station, which may include the first group of protocol layers corresponding to first overhead value 40 (FIG. 1) and the second group of protocol layers corresponding to second overhead value 40 (FIG. 1). Moreover, the components of UE 12 (FIG. 1) may be implemented at one of more of these protocol layers. For example, architecture 400 may be included in a UE such as UE 12 including application layer entity 46, uplink processing component 31, and modem 30.

The radio protocol architecture 400 for the UE 12 and network entity 14 is shown with three layers: Layer 1 406, Layer 2 408, and Layer 3 410. Layer 1 406 is the lowest lower and implements various physical layer signal processing functions. As such, Layer 1 406 includes the physical (PHY) layer 407. Layer 2 (L2 layer) 408 is above the physical layer 407 and is responsible for the link between the UE and node B over the physical layer 407. Layer 3 (L3 layer) 410 includes a radio resource control (RRC) layer 415 and an application layer 417. The RRC layer 415 handles the control plane signaling of Layer 3 between the UE 12 and network entity 14. The application layer 417 interfaces with the lower layers to transmit or receive data. In an aspect, the application layer 417 may correspond to an abstraction layer that specifies the shared protocols and interface methods used by hosts in a communications network, and may include an application layer entity, such as application layer entity 46 (FIG. 1) configured to operate one or more applications in the user plane 402.

In the user plane, the L2 layer 408 includes a media access control (MAC) layer 409, a radio link control (RLC) layer 411, and a packet data convergence protocol (PDCP) 413 layer, which are terminated at the node B on the network side. Moreover, the UE may have several upper layers above the L2 layer 408 including a network layer (e.g., IP layer) that is terminated at a PDN gateway on the network side, and an application layer 417 that is terminated at the other end of the connection (e.g., far end UE, server, etc.).

The PDCP layer 413 provides multiplexing between different radio bearers and logical channels. The PDCP layer 413 also provides header compression for upper layer data packets to reduce radio transmission overhead, security by ciphering the data packets, and handover support for UEs between node Bs. The RLC layer 411 provides segmentation and reassembly of upper layer data packets, retransmission of lost data packets, and reordering of data packets to compensate for out-of-order reception due to hybrid automatic repeat request (HARQ). The MAC layer 409 provides multiplexing between logical and transport channels. The MAC layer 409 is also responsible for allocating the various radio resources (e.g., resource blocks) in one cell among the UEs. The MAC layer 409 is also responsible for HARQ operations.

Furthermore, in the aspects described herein, the application layer entity 46 may be configured in the application layer 417 in Layer 3 410, the uplink processing component 31 comprising the determining component 32 and the adjusting component 50 may be configured at the either the MAC layer 490 and/or the physical (PHY) layer 407 in Layer 2 408 and/or Layer 1 406. Also, in an aspect, modem 30 may be configured at PHY layer 407 of Layer 1 406. Further, in an aspect, the first group of protocol layers corresponding to first overhead value 40 (FIG. 1) may comprise the IP, UDP, and RTP layers, which may be configured above the PDCP layer 413 in Layer 2 408 and/or Layer 3 410. Also, in an aspect, the second group of protocol layers corresponding to second overhead value 42 (FIG. 1) may comprise the PHY layer 407, the MAC layer 409 and/or the RLC layer 411.

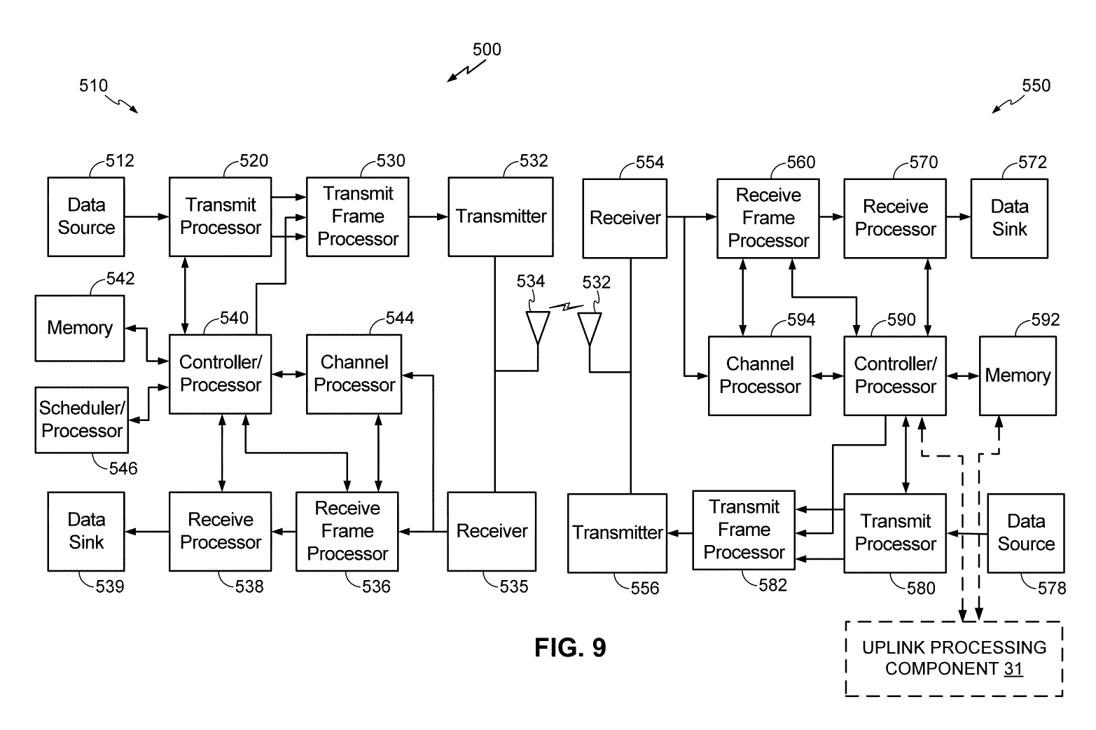

FIG. 9 is a block diagram of a Node B 510 in communication with a UE 550, where the Node B 510 may be the Node B 208 in FIG. 4, and the UE 550 may be the UE 210 in FIG. 5 or the UE 12 including uplink processing component 31 (FIG. 1) as described herein. In the downlink communication, a transmit processor 520 may receive data from a data source 512 and control signals from a controller/processor 540. The transmit processor 520 provides various signal processing functions for the data and control signals, as well as reference signals (e.g., pilot signals).

For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme.

These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols.

Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of adjusting an uplink communication by a user equipment (UE) during wireless communication, comprising:
determining uplink communication characteristic information corresponding to an uplink data rate based on one or more measurement values associated with transmissions by a modem on an uplink communication channel;
determining an adjusted uplink data rate based at least in part on the uplink communication characteristic information; and
adjusting data transmission rate of an application layer entity based at least in part on the adjusted uplink data rate.

2. The method of claim 1, wherein the uplink communication characteristic information includes one or both of a modem communication rate and a modem state, and wherein determining the adjusted uplink data rate includes selecting a smallest rate from an estimated modem communication rate and a filtered modem communication rate.

3. The method of claim 2, wherein the estimated modem communication rate is determined for each transmission time interval, and wherein the modem communication rate indicates a rate of data transmission for a time interval on an uplink communication channel.

4. The method of claim 2, further comprising filtering the estimated modem communication rate using a smoothing filter to produce the filtered modem communication rate, wherein the smoothing filter is configured to flatten a variation in the estimated modem communication rate.

5. The method of claim 4, wherein the filtered modem communication rate is determined based at least in part on a channel specific coefficient value and the estimated modem communication rate.

6. The method of claim 2, wherein the modem state comprises an indicator of an increasing or a decreasing rate of change of the modem communication rate at the modem entity.

7. The method of claim 1, further comprising:
identifying one of multiple modem states by determining whether a difference value between a current modem communication rate and a modem baseline rate meets or exceeds a modem state threshold value, wherein the modem state threshold value is configured differently for each distinct channel type; and
providing the modem state to the application layer entity to indicate one of an increase in a rate of change in the modem communication rate when the difference value meets or exceeds the modem state threshold value, a decrease in a rate of change in the modem communication rate when the difference value does not meet or exceed the modem state threshold value, or no change in the modem communication rate from a previous modem communication rate when the difference value does not meet or exceed the modem state threshold value.

8. The method of claim 1, wherein the uplink communication characteristic information includes overhead information associated with an uplink data transmission at the modem entity, wherein the overhead information includes one or both of a first overhead value corresponding to a first group of protocol layers and a second overhead value corresponding to a second group of protocol layers, wherein the first group of protocol layers includes one or more of an Internet Protocol (IP) layer, a User Datagram Protocol (UDP) layer, and a Real-Time Protocol (RTP) layer.

9. The method of claim 8, wherein determining the overhead information comprises determining the first overhead value by:
determining an average packet size value for an RTP packet;
determining a header value for each of an IP packet and a UDP packet;
summing the header value for each of the IP packet, the UDP packet and the RTP packet to obtain a summed header value; and
dividing the summed header value by a sum of the average packet size value for the RTP packet and the header values for the IP packet and the UDP packet to obtain the first overhead value.

10. The method of claim 8, wherein the second group of protocol layers comprises one or more of radio link control (RLC) protocol layer and/or a medium access control (MAC) protocol layer and/or a physical (PHY) protocol layer.

11. The method of claim 8, wherein determining the second overhead information comprises:
identifying whether an RLC packet is a fixed sized packet or a variable sized packet;
determining an average RLC packet size and an average RLC header size over a time duration value when the RLC packet is the variable sized packet;
determining an RLC packet size and an RLC header size for a single RLC packet when the RLC packet is the fixed sized packet; and
obtaining an overhead value for an RLC protocol layer by dividing the average RLC header size with the average RLC packet size, or by dividing the RLC header size with the RLC packet size.

12. The method of claim 11, further comprising:
determining an average medium access control (MAC) packet size and an average MAC header size over a time duration value;
obtaining an overhead value for a MAC protocol layer by dividing the average MAC header size with the average MAC packet size;
determining a difference value between a first transport block size and a second transport block size, wherein the difference value indicates a maximum padding size value for the average MAC packet size;
dividing the difference value by half to obtain a padding value at a physical (PHY) protocol layer; and
summing the overhead value for the RLC protocol layer, the overhead value for the MAC protocol layer, and the padding value at the PHY protocol layer to obtain the second overhead value.

13. An apparatus for adjusting an uplink communication at user equipment (UE) during wireless communication, comprising:
a determining component configured to determine uplink communication characteristic information corresponding to an uplink data rate based on one or more measurement values associated with transmissions by a modem on an uplink communication channel;
an adjusting component configured to determine an adjusted uplink data rate based at least in part on the uplink communication characteristic information; and
an application layer entity configured to adjust a data transmission rate based at least in part on the adjusted uplink data rate.

14. The apparatus of claim 13, wherein the uplink communication characteristic information includes one or both of a modem communication rate and a modem state, and wherein determining the adjusted uplink data rate includes selecting a smallest rate from an estimated modem communication rate and a filtered modem communication rate.

15. The apparatus of claim 14, wherein the estimated modem communication rate is determined for each transmission time interval, and wherein the modem communication rate indicates a rate of data transmission over or per a time interval on an uplink communication channel.

16. The apparatus of claim 14, wherein the determining component is further configured to filter the estimated modem communication rate using a smoothing filter to produce the filtered modem communication rate, wherein the smoothing filter is configured to flatten a variation in the estimated modem communication rate.

17. The apparatus of claim 16, wherein the filtered modem communication rate is determined based at least in part on a channel specific coefficient value and the estimated modem communication rate.

18. The apparatus of claim 14, wherein the modem state comprises an indicator of an increasing or a decreasing rate of change of the modem communication rate at the modem entity.

19. The apparatus of claim 13, wherein the determining component is further configured to identify one of multiple modem states by determining whether a difference value between a current modem communication rate and a modem baseline rate meets or exceeds a modem state threshold value, wherein the modem state threshold value is configured differently for each distinct channel type; and
wherein the determining component is further configured to provide the modem state to the application layer entity to indicate one of an increase in a rate of change in the modem communication rate when the difference value meets or exceeds the modem state threshold value, a decrease in a rate of change in the modem communication rate when the difference value does not meet or exceed the modem state threshold value, or no change in the modem communication rate from a previous modem communication rate when the difference value does not meet or exceed the modem state threshold value.

20. The apparatus of claim 13, wherein the uplink communication characteristic information includes overhead information associated with an uplink data transmission at the modem entity, wherein the overhead information includes one or both of a first overhead value corresponding to a first group of protocol layers and a second overhead value corresponding to a second group of protocol layers, wherein the first group of protocol layers includes one or more of an Internet Protocol (IP) layer, a User Datagram Protocol (UDP) layer, and a Real-Time Protocol (RTP) layer.

21. The apparatus of claim 20, wherein the determining component is further configured to determine the first overhead information by:
determining an average packet size value for an RTP packet;
determining a header value for each of an IP packet and a UDP packet;
summing the header value for each of the IP packet, the UDP packet and the RTP packet to obtain a summed header value; and
dividing the summed header value by a sum of the average packet size value for the RTP packet and the header values for the IP packet and the UDP packet to obtain the first overhead value.

22. The apparatus of claim 20, wherein the second group of protocol layers comprises one or more of radio link control (RLC) protocol layer and/or a medium access control (MAC) protocol layer and/or a physical (PHY) protocol layer.

23. The apparatus of claim 20, wherein the determining component is further configured to determine the second overhead information by:
identifying whether an RLC packet is a fixed sized packet or a variable sized packet;
determining an average RLC packet size and an average RLC header size over a time duration value when the RLC packet is the variable sized packet;
determining an RLC packet size and an RLC header size for a single RLC packet when the RLC packet is the fixed sized packet; and
obtaining an overhead value for an RLC protocol layer by dividing the average RLC header size with the average RLC packet size, or by dividing the RLC header size with the RLC packet size.

24. The apparatus of claim 23, wherein the determining component is further configured to:
determine an average MAC packet size and an average MAC header size over a time duration value;
obtain an overhead value for a MAC protocol layer by dividing the average MAC header size with the average MAC packet size;
determine a difference value between a first transport block size and a second transport block size, wherein the difference value indicates a maximum padding size value for the average MAC packet size;
divide the difference value by half to obtain a padding value at a physical (PHY) protocol layer; and
sum the overhead value for the RLC protocol layer, the overhead value for the MAC protocol layer, and the padding value at the PHY protocol layer to obtain the second overhead value.

25. A computer-readable medium storing computer executable code for adjusting uplink communication at user equipment (UE) during wireless communication, comprising:
code for determining uplink communication characteristic information corresponding to an uplink data rate based on one or more measurement values associated with transmissions by a modem on an uplink communication channel;
code for determining an adjusted uplink data rate based at least in part on the uplink communication characteristic information; and
code for adjusting data transmission rate of an application layer entity based at least in part on the adjusted uplink data rate.

26. The computer-readable medium of claim 25, wherein the uplink communication characteristic information includes one or both of a modem communication rate and a modem state, and wherein determining the adjusted uplink data rate includes selecting a smallest rate from an estimated modem communication rate and a filtered modem communication rate.

27. The computer-readable medium of claim 25, wherein the uplink communication characteristic information includes overhead information associated with an uplink data transmission at the modem entity, wherein the overhead information includes one or both of a first overhead value corresponding to a first group of protocol layers and a second overhead value corresponding to a second group of protocol layers, wherein the first group of protocol layers includes one or more of an Internet Protocol (IP) layer, a User Datagram Protocol (UDP) layer, and a Real-Time Protocol (RTP) layer.

28. An apparatus for adjusting uplink communication at a user equipment (UE) during wireless communication, comprising:
means for determining uplink communication characteristic information corresponding to an uplink data rate based on one or more measurement values associated with transmissions by a modem on an uplink communication channel;
means for determining an adjusted uplink data rate based at least in part on the uplink communication characteristic information; and
means for adjusting data transmission rate of an application layer entity based at least in part on the adjusted uplink data rate.

29. The apparatus of claim 28, wherein the uplink communication characteristic information includes one or both of a modem communication rate and a modem state, and wherein determining the adjusted uplink data rate includes selecting a smallest rate from an estimated modem communication rate and a filtered modem communication rate.

30. The apparatus of claim 28, wherein the uplink communication characteristic information includes overhead information associated with an uplink data transmission at the modem entity, wherein the overhead information includes one or both of a first overhead value corresponding to a first group of protocol layers and a second overhead value corresponding to a second group of protocol layers, wherein the first group of protocol layers includes one or more of an Internet Protocol (IP) layer, a User Datagram Protocol (UDP) layer, and a Real-Time Protocol (RTP) layer.
